(19) United States
(12) Patent Application Publication
(10) Pub. No.: US 2008/0276806 A1
(43) Pub. Date: Nov. 13, 2008

(54) WELDING SMOG DISPOSING MACHINE

(76) Inventor: Chieh-Yuan Cheng, Taichung (TW)

Correspondence Address: SINORICA, LLC, 528 FALLSGROVE DRIVE, ROCKVILLE, MD, 20850, US

(21) Appl. No.: 11/746,097

(22) Filed: May 9, 2007

(51) Int. Cl. B01D 46/00; B01D 46/22

(52) U.S. Cl. 96/414

(57) ABSTRACT

A welding smog-disposing machine includes a machine box partitioned into an air pumping space and a filtration space by a separating plate, with the lower end of the air pumping space and the filtration space communicating with each other. The air pumping space has one side bored with an opening, and a collecting box is provided at a proper location under the air pumping space and the separating plate for receiving and collecting embers dropping down through the opening of the air pumping space for obstructing the embers from entering the machine box. The filtration space has a filtration chamber and an exhaust chamber, and the filtration chamber is assembled with a movable filter cloth device for filtrating the oil smog and impurities produced during electric welding, effectively maintaining air quality in a work environment.

### BACKGROUND OF THE INVENTION

1. Field of the Invention

This invention relates to a welding smog disposing machine, particularly to one able to effectively dispose the smog and the embers produced during carrying out electric welding work.

2. Description of the Prior Art

Generally, when a metal welding factory carries out argon welding, electric welding or heat treatment, a great quantity of welding smog containing heavy metals like lead, manganese and nickel will be produced. To solve foresaid problem, such a factory is installed with industrial filtration equipment for carrying out filtration of air, and such filtration equipment is provided with one or more filter nets for carrying out air filtration. However, during the electric welding work, lots of oily dirt and impurities will be produced and, as a result, the filter nets are likely to be clogged with such oily dirt and impurities, and they have to be washed clean or replaced with new ones to avoid deteriorating the air around.

### SUMMARY OF THE INVENTION

The objective of this invention is to offer a welding smog-disposing machine, which is provided with a machine box partitioned into an air pumping space and a filtration space by a separating plate, with the lower end of the air pumping space and the filtration space communicating with each other. The air pumping space has one side bored with an opening, and the machine box has one side installed with a blower positioned in the air pumping space. A collecting box is provided at a proper location under the air pumping space and the separating plate. The filtration space is disposed with a filtration chamber and an exhaust chamber, with the filtration chamber assembled therein with a movable filter cloth device having one side fixed with a rotary ring. The exhaust chamber is positioned under the filtration chamber, communicating with the filtration chamber and provided with a filter plate set in the interior.

The collecting box in the present invention functions to receive and collect embers dropping down through the upper opening of the air pumping space for obstructing the embers from getting into the machine box, and the collecting box is designed in a drawer shape, convenient to be pulled out for pouring out the embers. The oil smog and foul air produced by the embers in the collecting box will be filtrated by the movable filter cloth device, which can be turned by the rotary ring to enable the filter cloth thereon to move forward for maintaining its excellent filtration condition, able to avoid trouble in disassembling, replacing and washing of the filter cloth. Thus, the air exhausted out of the machine box can be kept unpolluted.

### BRIEF DESCRIPTION OF DRAWINGS

This invention will be better understood by referring to the accompanying drawings, wherein:

FIG. 1 is a perspective view of a first preferred embodiment of a welding smog-disposing machine in the present invention;

FIG. 2 is an exploded perspective view of the first preferred embodiment of the welding smog-disposing machine in the present invention;

FIG. 3 is a cross-sectional view of the first preferred embodiment of the welding smog-disposing machine in the present invention;

FIG. 4 is a side cross-sectional view of the first preferred embodiment of the welding smog-disposing machine in the present invention;

FIG. 5 is a cross-sectional view of the first preferred embodiment of the welding smog disposing machine in a using condition in the present invention; and

FIG. 6 is a cross-sectional view of a second preferred embodiment of a welding smog disposing machine in the present invention.

### DETAILED DESCRIPTION OF THE PREFERRED EMBODIMENT

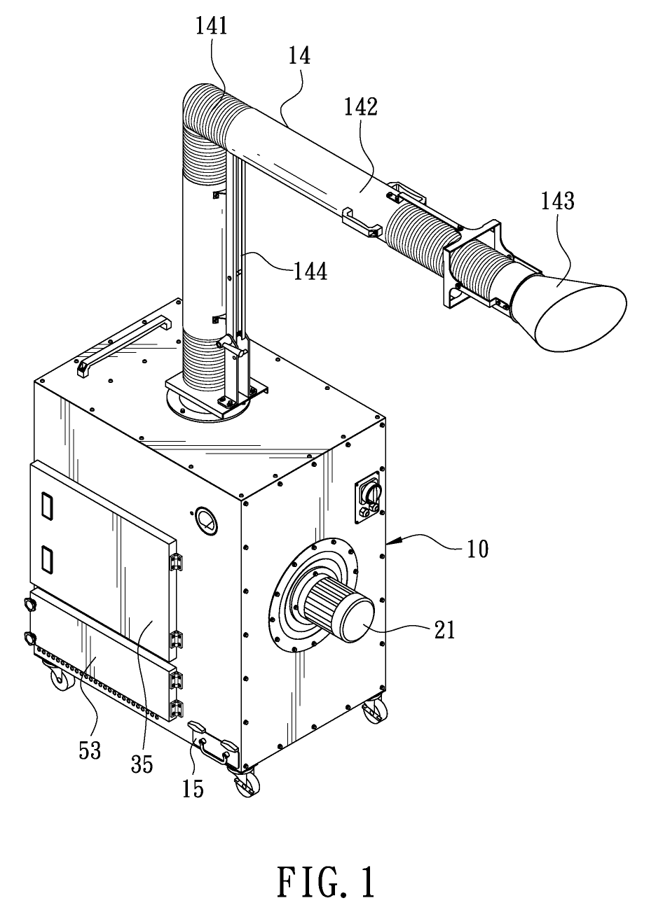

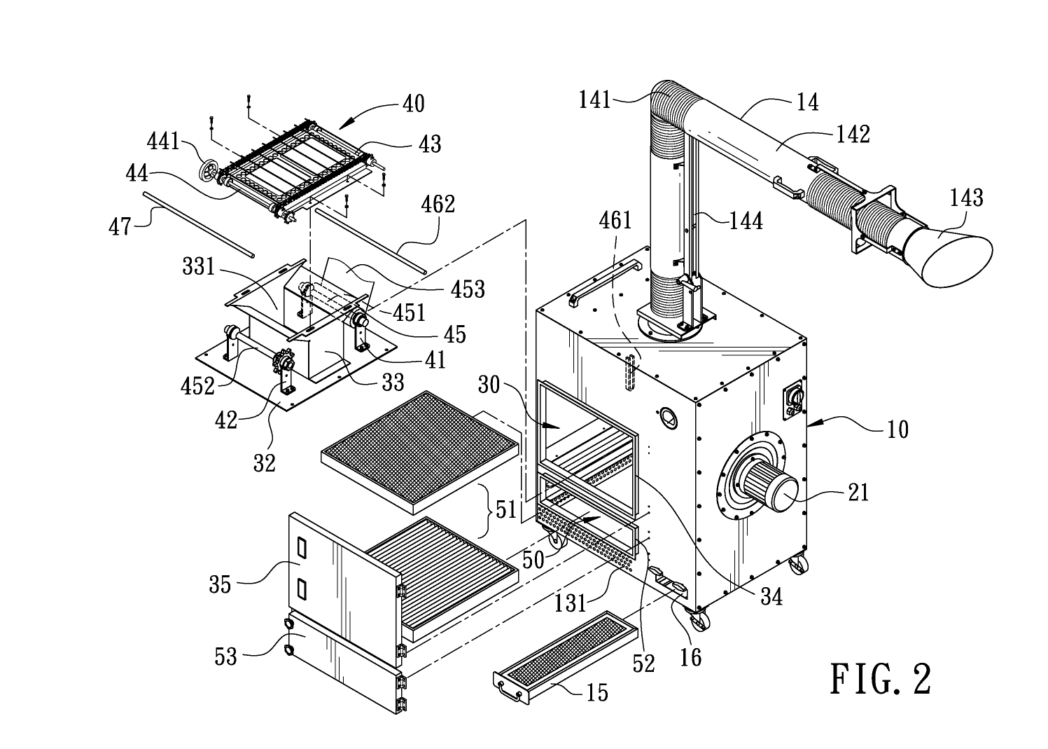

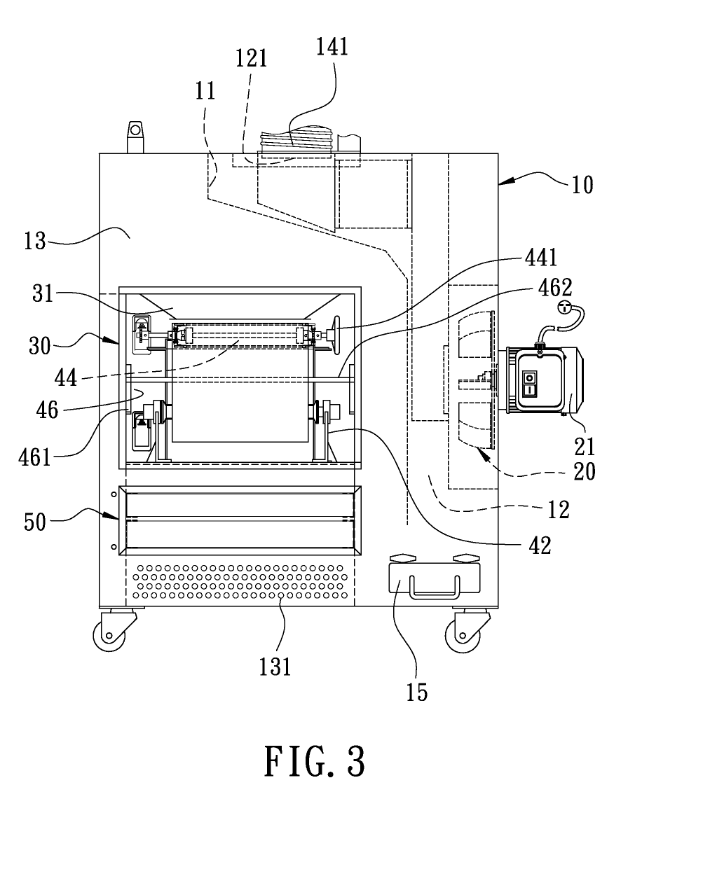

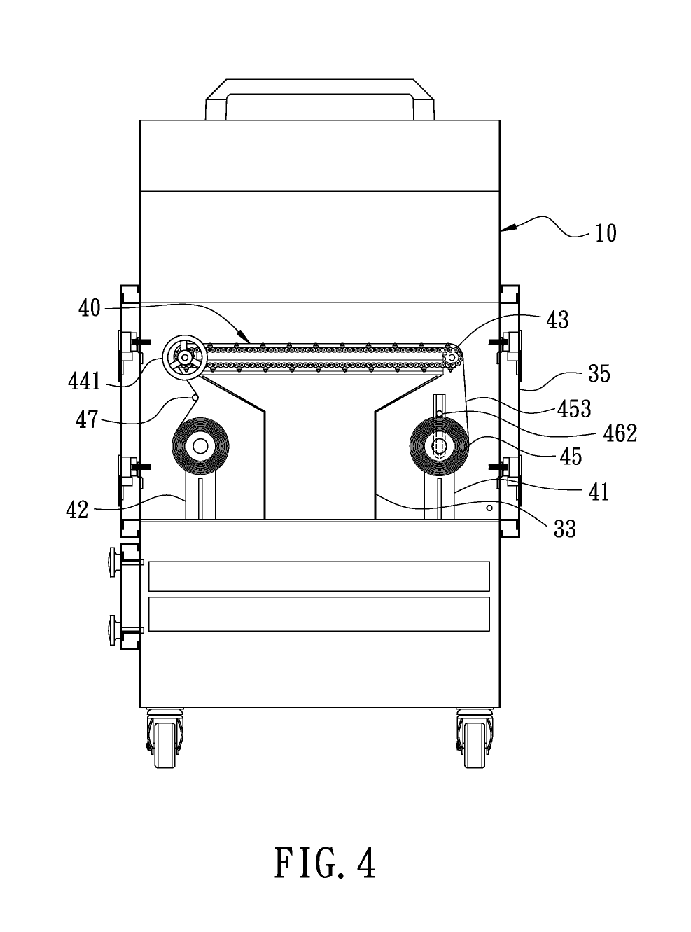

A first preferred embodiment of a welding smog disposing machine in the present invention, as shown in FIGS. 1 to 5, includes a machine box 10, a blower 20, a filtration chamber 30, a movable filter cloth device 40 and an exhaust chamber 50 as main components combined together.

The machine box 10 is partitioned into an air pumping space 12 and a filtration space 13 by means of a separating plate preset in length, with the lower side of the air pumping space 12 and the filtration space 13 communicating with each other. The air pumping space 12 of the machine box 10 has one side bored with an opening 121 for embers to get into the air pumping space 12 therethrough. In this preferred embodiment, the opening 121 is positioned at the topside of the air pumping space 12 and connected with an external air pumping pipe 14 of a preset length and made up by connecting plural contractible pipes 141 with plural hollow pipes 142. The air pumping pipe 14 has its outer end connected with an air suction shade 143 and its inner side fixed with a support frame 144 for controlling the air pumping pipe 14 to be bent to a proper position. Further, a collecting case 15 is disposed at a proper location under the air pumping space 12 and the separating plate 11 for receiving and collecting the embers dropping down through the opening 121 of the air pumping space 12. The filtration space 13 has one lower side bored with plural rows of air holes 131. In this preferred embodiment, the collecting box 15 is designed in a drawer shape, and the machine box 10 has one lower side bored with an insert groove 16 at a location corresponding to the collecting case 15 for receiving the collecting case 15 therein and facilitating it to be removed for pouring out embers.

The blower 20 is assembled at one inner side of the machine box 10 and positioned inside the air pumping space 12, connected with an external driving motor 21 for driving the blower 20 to operate.

The filtration chamber 30 positioned inside the filtration space 13 has its upper side bored with an opening 31 communicating with the filtration space 13 and its bottom disposed with a support plate 32 mounted thereon with a funnel 33 having its topside formed with an opening 331. In addition, one side of the filtration chamber 30 is bored with an opening 34 having a door plank 35 pivotally assembled thereon for opening and closing the filtration chamber 30.

The movable filter cloth device 40 is assembled above the support plate 32 in the filtration chamber 30, consisting of a first winding base 41, a second winding base 42, a driving shaft 43, a rotary shaft 44, a filter cloth winder 45 and a press unit 46. The first winding base 41 and the second winding base 42 are fixed above the support plate 32 and respectively positioned at the front and the rear side of the funnel 33. The driving shaft 43 and the rotary shaft 44 are respectively set in parallel at the opposite sides of the filtration chamber 30 and respectively positioned above the first and the second winding base 41, 42. The filter cloth winder 45 is composed of a first shaft tube 451, a second shaft tube 452 and filtration cloth 453. The first shaft tube 451 is movably and pivotally fitted on the first winding base 41, while the second shaft tube 452 is movably and pivotally fitted on the second winding base 42. The filtration cloth 453 has one end wound on the first shaft tube 451 and the other end pulled upward to pass on the driving shaft 43 and the rotary shaft 44 to cover on the opening 331 at the upper side of the funnel 33 between the driving shaft 43 and the rotary shaft 44, hiding the upper opening 31 of the filtration chamber 30 for filtrating the oil smog and foul air getting into the filtration chamber 30 through the opening 31. Then, the filtration cloth 453 is downward wound on the second shaft tube 452. The rotary shaft 44 has one end fixed with a rotary ring 441 for turning the rotary shaft 44 together with the filtration cloth 453 to let the filtration cloth winder 45 drive the driving shaft 43 to shift and actuate the first shaft tube 451 to roll the filtration cloth 453.

The press unit 46 positioned at the opposite inner sides of the filtration chamber 30 is composed of two U-shaped position-limiting groove sockets 461 and a press rod 462. The two position-limiting groove sockets 461 are longitudinally disposed on sidewalls of the filtration chamber 30 and respectively facing to the opposite sides of the first winding base 41. The press rod 462 has its opposite ends respectively fitted in the two position-limiting groove sockets 461, letting the press rod 462 transversely positioned on the filtration cloth 453 wound on the first shaft tube 451 for pressing against the filtration cloth 453 with its own weight. Thus, when actuated to rotate, the filtration cloth 453 can evenly and smoothly be rolled and delivered outward. Further, a cross rod 47 is provided between the rotary shaft 44 and the second winding base 42, having its opposite ends secured at the opposite inner sides of the filtration chamber 30. The cross rod 47 functions to press inward the filtration cloth 453 positioned between the rotary shaft 44 and the second wind base 42 to let the filtration cloth 453 produce a tension force. Thus, after being pressed smoothly by the cross rod 47, the filtration cloth 453 can conveniently and evenly be wound on the second winding base 42.

The exhaust chamber 50 is provided in the filtration space 13, positioned under the filtration chamber 30 and communicating with the funnel 33. The exhaust chamber 50 has its interior disposed with a filtration plate set 51 and one side bored with an opening 52 having a door plank 53 pivotally assembled thereon for opening or closing the exhaust chamber 50.

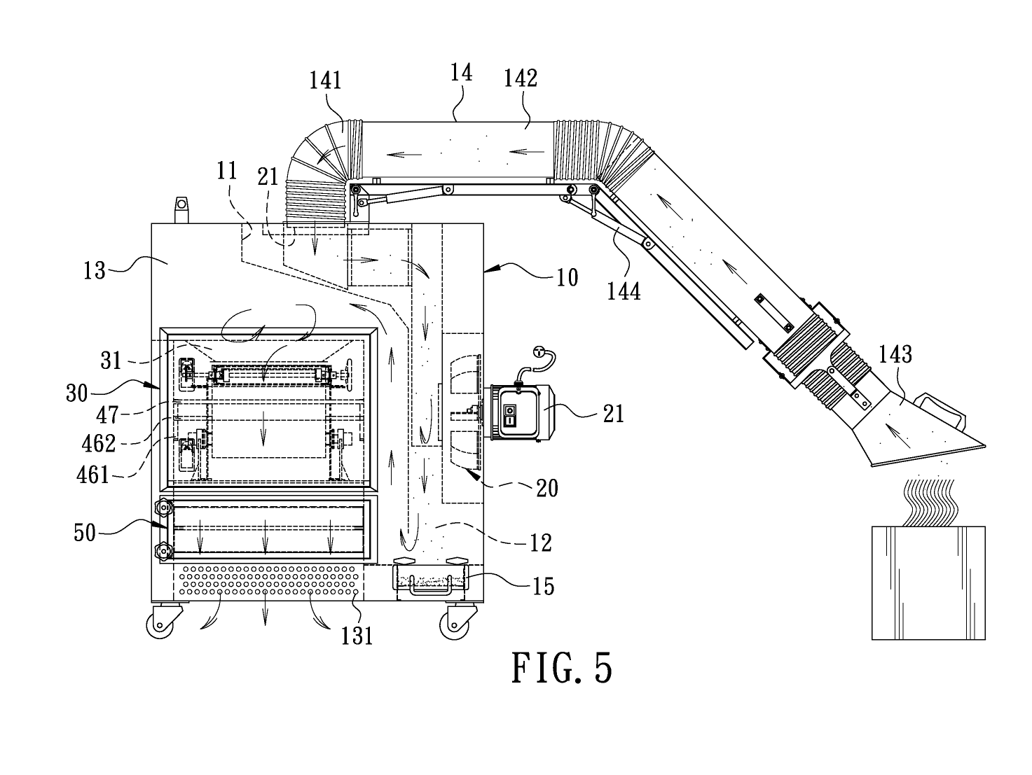

In using, as shown in FIG. 5, during carrying out electric welding work, the welding smog disposing machine of this invention is placed at a proper location and its air pumping pipe 14 is bent by means of the support frame 144 and adjusted to a proper level matching with an electric welding machine table, letting the air suction shade 143 of the air pumping pipe 14 properly aligned to the electric welding machine table.

Thus, by rotation of the blower 20, the embers produced during electric welding will be sucked into the air pumping pipe 14 through the air suction shade 143 and then get into the air pumping space 12 10 through the opening 121. Simultaneously, the embers will be pumped by the blower 20 to drop into the collecting box 15 along the separating plate 11 to be collected in the collecting box 15 that can be drawn out anytime for throwing out the embers. At this time, the foul air and the oil smog produced by the embers will be exhausted out of the collecting box 15 to get to the lower end of the air pumping space 12 and then pumped by the blower 20 into the filtration space 13, which communicates with the lower end of the air extracting space 12, to be filtrated by the filtration chamber 30 in the filtration space 13. Afterward, the foul air and the oil smog will get to the movable filter cloth device 40 through the upper opening 31 of the filtration chamber 30 to be filtrated, and at this time, the foul air and the oil smog are blocked by the filtration cloth 453 on the shade 33 and the air, after filtrated by the movable filter cloth device 40, will pass through the funnel 33 and get into the exhaust chamber 50 beneath the funnel 33 to be filtrated for the last time by the filter plate set 51 in the exhaust chamber 50. Then, this unpolluted air is sent out of the machine box 10 through the air holes 131 at one lower side of the filtration space 13.

After the filtration cloth 453 held between the driving shaft 43 and the rotary shaft 44 has been used for a period of time, it has to be replaced with a new one. To replace the used filtration cloth 453, only open the door plank 35 of the filtration chamber 30 and then turn the rotary ring 441 of the rotary shaft 44 to actuate the filtration cloth 453 wound on the first shaft tube 451 to move upward and forward and be wound on the second shaft tube 452, finishing replacing the used filtering cloth 453.

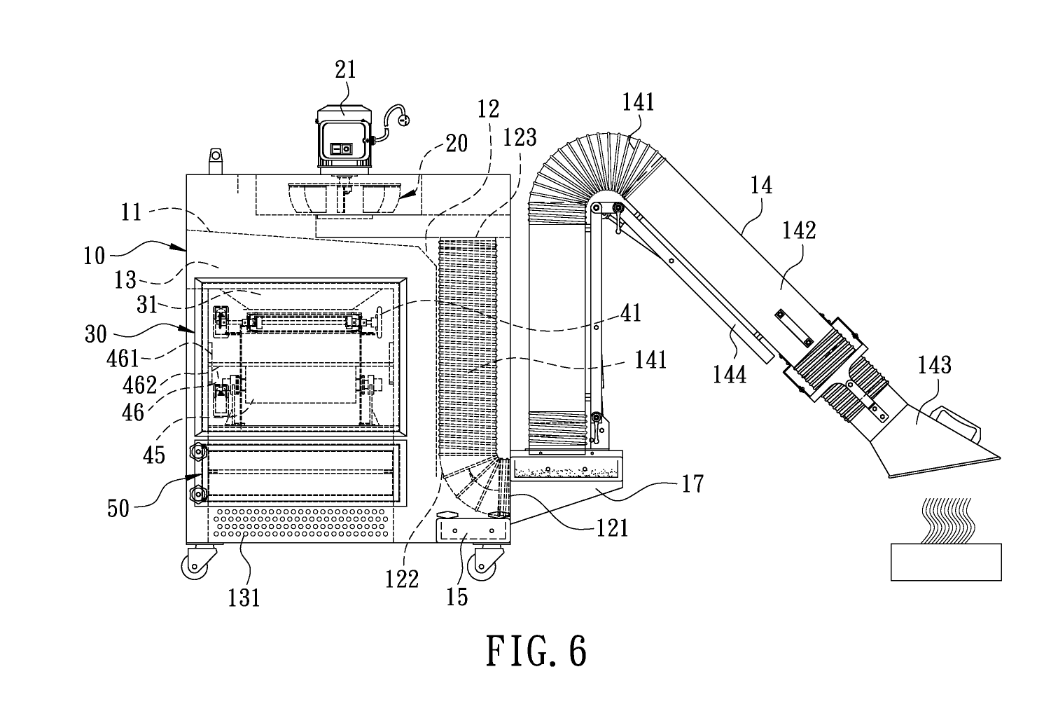

A second preferred embodiment of a welding smog disposing machine in the present invention, as shown in FIG. 6, has almost the same structure as that of the first preferred embodiment, except that the opening 121 of the air pumping space 12 is formed at one lower side of the air pumping space 12, and a connecting base 17 is secured at the outer side of the opening 121 and the air pumping space 12. The connecting base 17 has its upper end connected with the air pumping pipe 14, communicating with both the air pumping pipe 14 and the opening 121. A contractible pipe 141 is positioned in the air pumping space 12 and fitted with the opening 121, bent upward and parallel to the separating plate 11, with a gap 122 formed between the contractible pipe 141 and the separating plate 111. The contractible pipe 141 has its upper end connected with an air outlet 123 bored at the upper side of the air pumping space 12, and the blower 20 is assembled at the topside of the air pumping space 12.

As can be understood from the above description, this invention has the following advantages.

1. The press rod of the press unit functions to press against the filtration cloth to enable the filtration cloth to be evenly wound and delivered out when the movable filter cloth device is turned. Further, the cross rod disposed between the rotary shaft and the second winding base can hold and press inward the filtration cloth wound between the rotary shaft and the second winding base to let the filtration cloth produce a tension force and kept smooth for facilitating the filtration cloth to be wound evenly on the second winding base.

2. The embers produced during electric welding are pumped to drop into the collecting box to be collected so as to prevent the embers from getting into the machine box and causing potentially a fire or gas explosion, and the collecting box can conveniently and timely be drawn out for throwing out the embers. Further, foul air produced during electric welding can be filtrated by both the movable filter cloth device and the filter plate set in the air exhaust chamber; therefore, the air exhausted out is unpolluted, effectively maintaining good quality of air in the work environment.

3. The movable filter cloth device and the filter plate set can be disassembled and replaced conveniently, and the rotary ring of the movable filter cloth device can be turned manually to actuate the filter cloth winder to rotate, needless to provide any power-driven device, saving electricity and able to prolong the service life.

While the preferred embodiments of the invention have been described above, it will be recognized and understood that various modifications may be made therein and the appended claims are intended to cover all such modifications that may fall within the spirit and scope of the invention.

I claim:

1. A welding smog-disposing machine comprising:
a machine box partitioned into an air pumping space and a filtration space by a separating plate of a present length, lower ends of said air pumping space and said filtration space communicating with each other, said air pumping space having one side bored with an opening for embers to drop in said air pumping space therethrough, a collecting box provided at a proper location under said air pumping space and said separating plate for receiving and collecting said embers;
a blower assembled at one side of said machine box and positioned in said air pumping space, said blower connected with an external driving motor for driving said blower to operate;
a filtration chamber formed in said filtration space, said filtration chamber having its upper side bored with an opening communicating with said filtration space, said filtration chamber disposed with a funnel in its interior, said filtration chamber having each side bored with an opening, said opening pivotally assembled thereon with a door plank, said filtration chamber provided with a movable filter cloth device in the interior, said movable filter cloth device composed of a first winding base, a second winding base, a driving shaft, a rotary shaft, a filter cloth winder and a press unit, said first and said second winding base respectively positioned at a front side and a rear side of said funnel, said driving shaft and said rotary shaft respectively fixed above and parallel to said first and said second winding base, said filter cloth winder composed of a first shaft tube, a second shaft tube and a filtration cloth, said first shaft tube movably and pivotally fitted on said first winding base, said second shaft tube movably and pivotally fitted on said second winding base, said filtration cloth having one end wound on said first shaft tube and the other end drawn upward to pass on both said driving shaft and said rotary shaft, said filtration cloth covering on said funnel between said driving shaft and said rotary shaft, said filtration cloth then drawn downward and wound on said second shaft tube, said rotary shaft having one end secured with a rotary ring for turning said rotary shaft, said rotary shaft turned to drive said filter cloth winder and actuate said driving shaft to shift, said driving shaft actuating said first shaft tube to wind said filtration cloth, said press unit composed of two position-limiting groove sockets and a press rod, said two position-limiting groove sockets longitudinally fixed on sidewalls of said filtration chamber and respectively facing to opposite ends of said first winding base, said press rod having its opposite ends respectively positioned in said two position-limiting groove sockets and transversely pressed on said filtration cloth; and
an exhaust chamber disposed in said filtration space and positioned under said filtration chamber, said exhaust chamber communication with said funnel, said exhaust chamber assembled with a filter plate set in the interior and having one side bored with an opening pivotally assembled thereon with a door plank.

2. The welding smog disposing machine as claimed in claim 1, wherein said opening in said pumping space is bored at an upper end thereof.

3. The welding smog disposing machine as claimed in claim 2, wherein said opening of said air pumping space is connected with an external pumping pipe of a preset length, said pumping pipe made up by connecting plural contractible pipes with plural hollow pipes, said pumping pipe having its outer end assembled with an air suction shade and its inner side fixed with a support frame.

4. The welding smog disposing machine as claimed in claim 1, wherein said opening of said pumping space is provided at the lower side of said air pumping space and positioned above said collecting box.

5. The welding smog disposing machine as claimed in claim 4, wherein said opening and said pumping space have the outer side secured with a connecting base having its upper side connected with an air pumping pipe communicating with said opening of said air pumping space, said air pumping pipe preset in length and made up by connecting plural contractible pipes with plural hollow pipes, said air pumping pipe having its outer end assembled with an air suction shade and its inner side fixed with a support frame.

6. The welding smog disposing machine as claimed in claim 1, wherein said contractible pipe is positioned inside said air pumping space and fitted on said opening and bent upward to be parallel to said separating plate, with a gap formed between said contractible pipe and said separating plate, said contractible pipe having its upper end connected with an air outlet bored at the upper side of said air pumping space.

7. The welding smog disposing machine as claimed in claim 1, wherein a cross rod is provided between said rotary shaft and said second winding base and has its opposite ends respectively fixed at the opposite inner sides of said filtration chamber.

8. The welding smog disposing machine as claimed in claim 1, wherein said position-limiting grooves sockets have a U-shaped groove.
